(19) United States
(12) Patent Application Publication
(10) Pub. No.: US 2010/0103244 A1
(43) Pub. Date: Apr. 29, 2010

(54) DEVICE FOR AND METHOD OF PROCESSING IMAGE DATA REPRESENTATIVE OF AN OBJECT

(75) Inventors: Ewout Brandsma, Eindhoven (NL); Aly Syed, Deurne (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/532,323

(22) PCT Filed: Mar. 19, 2008
(86) PCT No.: PCT/IB2008/051034

§ 371 Date: Sep. 21, 2009

(30) Foreign Application Priority Data
Mar. 30, 2007 (EP) 07105409.2

(51) Int. Cl. H04N 7/15; H04N 13/02

(52) U.S. Cl. 348/14.08; 348/47; 348/E13.074; 348/E07.083

(57) ABSTRACT

A device (100) for processing image data representative of an object (201), wherein the device (100) comprises a first image-processing-unit (101) adapted for generating three-dimensional image data (102) of the object (201) based on two-dimensional image input data (103 to 105) representative for a plurality of two-dimensional images of the object (201) from different viewpoints, a second image-processing-unit (106) adapted for generating two-dimensional image output data (107) of the object (201) representative of a two-dimensional view of the object (201) from a predefined viewpoint, and a transmitter unit (109) adapted for providing the two-dimensional image output data (107) for transmission to a communication partner which is communicatively connectable to the device (100).

### FIELD OF THE INVENTION

The invention relates to a device for processing image data.

Moreover, the invention relates to a method of processing image data.

Beyond this, the invention relates to a program element.

Furthermore, the invention relates to a computer-readable medium.

### BACKGROUND OF THE INVENTION

A videoconference is a live connection between people at separate locations for the purpose of communication, usually involving video, audio and often text as well. Videoconferencing may provide transmission of images, sound and optionally text between two locations. It may provide the transmission of full-motion video images and high-quality audio between multiple locations.

U.S. Pat. No. 6,724,417 discloses that a view morphing algorithm is applied to synchronous collections of video images from at least two video imaging devices. Interpolating between the images creates a composite image view of the local participant. This composite image approximates what might be seen from a point between the video imaging devices, presenting the image to other video session participants.

However, conventional videoconference systems may still lack sufficient user-friendliness.

### OBJECT AND SUMMARY OF THE INVENTION

It is an object of the invention to provide a user friendly imaging processing system.

In order to achieve the object defined above, a device for processing image data, a method of processing image data, a program element, and a computer-readable medium according to the independent claims are provided.

According to an exemplary embodiment of the invention, a device for processing image data representative of an object (such as an image of a person participating on a videoconference) is provided, wherein the device comprises a first image-processing-unit adapted for generating three-dimensional image data of the object (such as a steric model of the person or a body portion therefore, for instance a head) based on two-dimensional image input data representative for a plurality of two-dimensional images of the object from different viewpoints (such as planar images of the person as captured by different cameras), a second image-processing-unit adapted for generating two-dimensional image output data of the object representative of a two-dimensional view of the object from a predefined viewpoint (which usually differs from the different viewpoints related to the different 2D images), and a transmitter unit adapted for providing (at a communication interface) the two-dimensional image output data for transmission to a communication partner (such as a similar device, like a communication partner device, acting as a recipient unit at a remote position) which is communicatively connectable or connected to the device.

According to another exemplary embodiment of the invention, a method of processing image data representative of an object is provided, wherein the method comprises generating three-dimensional image data of the object based on two-dimensional image input data representative for a plurality of two-dimensional images of the object from different viewpoints, generating two-dimensional image output data of the object representative of a two-dimensional view of the object from a predefined viewpoint, and providing the two-dimensional image output data for transmission to a communicatively connected communication partner.

According to still another exemplary embodiment of the invention, a program element (for instance an item of a software library, in source code or in executable code) is provided, which, when being executed by a processor, is adapted to control or carry out a data processing method having the above mentioned features.

According to yet another exemplary embodiment of the invention, a computer-readable medium (for instance a CD, a DVD, a USB stick, a floppy disk or a harddisk) is provided, in which a computer program is stored which, when being executed by a processor, is adapted to control or carry out a data processing method having the above mentioned features.

The data processing scheme according to embodiments of the invention can be realized by a computer program, that is by software, or by using one or more special electronic optimization circuits, that is in hardware, or in hybrid form, that is by means of software components and hardware components.

The term “object” may particularly denote any region of interest on an image, particularly a body part such as a face of a human being.

The term “three-dimensional image data” may particularly denote electronic data which include the information of a three-dimensional, that is steric, characteristic of the object.

The term “two-dimensional image data” may particularly denote a projection of a three-dimensional object onto a planar surface, for instance a sensor active surface of an image capturing device such as a CCD (“charge coupled device”).

The term “viewpoint” may determine an orientation between the object and a sensor surface of the corresponding image capturing device.

The term “transmitter” may denote the capability of broadcasting or sending two-dimensional projection data from the device to a communication partner device which may be coupled to the device via a network or any other communication channel.

The terms “receiver”, “recipient” or “communication partner” may denote an entity which is capable of receiving (and optionally decoding and/or decompressing) the transmitted data in a manner that the two-dimensional image projected on the predetermined viewpoint can be displayed at a position of the receiver which may be remote from a position of the transmitter.

According to an exemplary embodiment of the invention, an image data (particularly a video data) processing system may be provided which is capable of pre-processing video data of an object captured at a first location for transmission to a (for instance remotely located) second location. The pre-processing may be performed in a manner that a two-dimensional projection of an object image captured at the first position, averaged over different capturing viewpoints and therefore mapped/projected onto a modified position can be supplied to a recipient/communication partner in a manner that the viewing orientation is related to a predefined viewpoint, for instance a center of a display on which an image can be displayed at the first location. By taking this measure, only a relatively small amount of data (due to a data reduction resulting from the re-calculation of a three-dimensional model of the object into a two-dimensional projection) has to be transmitted to a receiving entity so that a fast and therefore essentially real time transmission is made possible, and any conventional data communication channel may be used. Even more important is that backward compatibility may be achieved according to the transfer of 2D data instead of 3D data from the data source to the data destination, since this allows to implement the data destination with a conventional cheap videoconference system and with a low cost data communication capability. At the recipient side, this information may be displayed on the display device so that a videoconference may be carried out between devices located at the two positions in a manner that, as a result of the projection of the three-dimensional model onto a predefined viewpoint, it is possible to generate a realistic impression of an eye-to-eye contact between persons located at the two locations.

Thus, a virtual camera inside (or in a center region of) a display screen area for videoconferencing may be provided. This may be realized by providing a videoconference system where a number of cameras are placed for instance at edges of a display for creating a three-dimensional model of a person's face, head or other body part in order to generate a perception for persons communicating via a videoconference to look each other in the eyes.

According to an exemplary embodiment, a device is provided comprising an input unit adapted to receive data signals of multiple cameras directed to an object from different viewpoints. 3D processing means may be provided and adapted to generate three-dimensional model data of the object based on the captured data signals. Beyond this, a two-dimensional processing unit may be provided and adapted to create, based on the 3D model data, 2D data representative of a 2D view of the object from a specific viewpoint. Furthermore, an output unit may be provided and adapted to encode and provide the derived two-dimensional data to a codec (encoder/decoder) of a recipient unit. Particularly, such an embodiment may be part of or may form a videoconference system. This may allow for an improved video conferencing experience for the users. Particularly, embodiments of the invention are applicable to videoconference systems including TV sets with a video chat feature.

According to an exemplary embodiment of the invention, two or more cameras may be mounted on edges of a screen. The different camera views of the person may be used to create a three-dimensional model of a person's face. This three-dimensional model of the face may be subsequently used to create a two-dimensional projection of the face from an alternative point of view, particularly a center of the screen (which is a position of the screen at which persons usually look at). In other words, the different camera views may be “interpolated” to create a virtual (i.e. not real, not physical) camera in the middle of the screen. An alternative embodiment of the invention may track the position of the face of the other person on the local screen. Subsequently, that position on the screen may be used to make a two-dimensional projection of the own face before transmission. By taking this measure, it is still possible to look a person in the eyes (or vice versa) who is not properly centered on the screen. A similar principle can also be used to position real cameras with servo control (as opposed to a virtual camera/two-dimensional projection), although this may involve a hole-in-the-screen challenge. Thus, according to an exemplary embodiment, it is possible to use face tracking of a return channel to position real cameras with servo control.

Inter alia, the following components which may be known as such and individually, may be combined in an advantageous manner according to exemplary embodiments of the invention:
Video conferencing with one or usually more cameras close to the screen (for instance just on top)
Use of multiple cameras to create a three-dimensional model of an object
Using (additionally) a history of past images from one or more cameras to create a three-dimensional model
Creating a two-dimensional projection of a three-dimensional model from a certain viewpoint
Face tracking (or eye tracking)

Such components which may be known as such and individually, and which may be combined in an advantageous manner according to exemplary embodiments of the invention are disclosed for instance in US 2003/0218672, US 2005/0129325, U.S. Pat. No. 6,724,417, or in Kauff, P., Schreer, O., “An immersive 3D video-conferencing system using shared virtual team user environments”, Proceedings of the 4th international conference on Collaborative virtual environments, p. 105-112, Sep. 30-Oct. 2, 2002, Bonn, Germany.

In a real world conversation, people are able to look each other in the eye. For a videoconference with a “personal” experience, a similar result can be obtained in an automatic manner by exemplary embodiments of the invention.

However, a person can either look straight at the other person appearing on the screen, or the person can look straight at the camera, which is, for example, located on top of the screen. In either case, both people do not look each other to their eyes (virtually on the screen). Therefore, as has been recognized by the inventors, the camera should be ideally mounted in the center of the screen. Physically and technically, this possibility of “looking each other to the eyes” feature is difficult to achieve with current display technologies, at least not without leaving a hole in the screen. However, according to an exemplary embodiment of the invention, it may also be possible to position one or more real cameras on a display area of a display device, for instance in a hole provided in such a display area.

According to an exemplary embodiment of the invention, several cameras such as CCD cameras may be mounted (spatially fixed, rotatably, movable in a translative manner, etc.) at suitable positions, for instance at edges of the screen. However, they may also be mounted at appropriate positions in the three-dimensional space, for instance on the wall or ceiling of a room in which the system is installed. From at least two camera views, a steric model of the person's body part of interest, for instance eyes or face, may be performed. On the basis of this three-dimensional model, a planar projection may be created to show the body part of interest from a selectively or predetermined viewpoint. This viewpoint may be the middle of the screen which may have the advantageous effect that persons communicating during a videoconference have the impression to look in the eyes of their communication partner.

According to another embodiment, the position of the face of the other (remote) person may be tracked on the local screen. Or more specifically, it may possible to track the point right between the eyes of the person. Subsequently, that position on the screen may be taken as a basis for making a planar projection of the own face before transmission to the communication partner. The different camera views may then be interpolated or evaluated in common for generating a virtual camera in the middle of the other person's face appearing on the screen. Looking at that person on the screen, a user will look right into the (virtual) camera. This way it is still possible to look a person in the eye who is not centered properly on a screen. This may improve the experience of a user during a videoconference.

By sending a standard two-dimensional video data stream (which may allow for a backward compatible operation of the system) over a wired or over a wireless communication channel, a significantly improved system is provided in contrast to sending a three-dimensional model over the communication channel (which would not be backward compatible). Both solutions allow an automatic adaptation of the image rendered to the viewpoint of a second communication peer, rather than having a fixed (virtual) camera position in the middle of the screen of a first communication peer. However, it is highly favourable to create the two-dimensional projection at the sending side, and not at the receiving side, in order to reduce the amount of data to be transmitted. Moreover, this may allow for backward compatibility (conventional 2D codec plus no extra signaling). In a large network, each device according to an embodiment of the invention that is added to the network may create immediate benefits.

According to an exemplary embodiment of the invention, an image received from the second peer may be used. By performing face tracking (and assuming a standard viewing distance by the second peer), it is possible to determine the position of the head at the second position relative to the screen of this user. As also the two-dimensional projection is already done at the sending side, namely the first peer, it is still not necessary to additionally signal the position of the head of the user at the second peer (in other words: it is possible to remain backward compatible). Signalling may therefore be implicit (and hence backward compatible) by analyzing (face tracking) the video from the return path.

Tracking the head of the user at the recipient's location, it is possible to create a projection from the correct viewpoint. Therefore, according to an exemplary embodiment of the invention, face tracking may be used in a return path to determine a viewpoint for a two-dimensional projection.

According to an exemplary embodiment, multiple cameras and a 3D modelling scheme may be used to create a virtual camera from the perspective of the viewer. In this context, the 3D model is not sent over the communication channel between sender and receiver. In contrast to this, two-dimensional mapping is already performed at the sending side so that regular two-dimensional video data may be sent over the communication channel. Consequently, complex communication paths as needed for three-dimensional model data transmission (such as object-based MPEG4 or the like) may be omitted.

This may further allow using any codec that is common among teleconference equipment (for instance H.263, H.264, etc.). According to an exemplary embodiment of the invention, this is enabled because the head position of the spectator on the other side of the communication channel is determined implicitly by performing face tracking on the video received from the other side. Actually, to really determine the position of the head of the other person (to calculate the person's perspective), it may be also advantageous to know the distance between the person and the display/cameras. This can be measured by corresponding sensor systems, or a proper assumption may be made for that. However, in such a scenario, this may involve additional signaling.

Therefore, a main benefit obtainable by embodiments of the invention is a high degree of interoperability. It is possible to interwork with any regular two-dimensional teleconference system as commercially available (such as mobile phones, TVs with a video chat, net meeting, etc.) using standardized protocols and codecs.

When such a three-dimensional teleconference system interoperates with a regular two-dimensional teleconference system, the communication party at the other side (that is the one using the regular system) will see the person from the correct perspective. In this way, the sender may bring a message properly across. It is possible to look the other person in the eye.

According to an exemplary embodiment of the invention, a two-way communication system may be provided with which it may be ensured that two people look each other in the eyes although communicating via a videoconference arrangement. To enable this, 2D data may be transmitted to instruct the communication partner device how to display data, capture data, process data, manipulate data, and/or operate devices (for instance how to adjust turning angles of cameras). In this context, face tracking may be appropriate. 2D data may be exchanged in a manner to enable a 3D experience.

Next, exemplary embodiments of the device will be explained. However, these embodiments also apply to the method, to the program element and to the computer-readable medium.

The device may comprise a plurality of image capturing units each adapted for generating a portion of the two-dimensional image input data, the respective data portion being representative for a respective one of the plurality of two-dimensional images of the object from a respective one of the different viewpoints. In other words, a plurality of cameras such as CCD cameras may be provided and positioned at different locations, so that images of the object from different viewing angles and/or distances may be captured as a basis for the 3D modelling.

A display unit may be provided and adapted for displaying an image. On the display unit, an image of a communication partner with which a user of the device has presently a teleconference, may be displayed. Such a display unit may be an LCD, a plasma device or even a cathode ray tube. A user of the device will look in the display unit (particularly to a central portion thereof) when having a videoconference with another party. By the “multiple 2D“−”3D“−”2D” conversion scheme of exemplary embodiments of the invention, it is possible to calculate an image of the person which corresponds to an image which would be captured by a camera located in a center of the display device. By transmitting this artificial image to the communication partner, the communication partner gets the impression that the person looks directly into the eyes of the other person.

The plurality of image capturing units may be mounted at respective edge portions of the display unit. These portions are suitable for mounting cameras, since this mounting scheme is not disturbing from the technical and aesthetical point of view, for a videoconference system. Furthermore, images taken from such positions include in many cases information regarding the viewing direction of the user, thereby allowing to manipulate the displayed images on one or both sides of the communication system to allow the impression of an eye contact.

A first one of the plurality of image capturing units may be mounted at a central position of an upper edge portion of this display unit. A second one of the plurality of image capturing units may be mounted at a central position of a lower edge portion of the display unit. Rectangular display units usually have longer upper and lower edge portions than left and right edge portions. Thus, mounting two cameras on central positions of the upper and lower edge introduces less perspective artefacts, due to the reduced distance. For instance, such a configuration may be a two-camera configuration with cameras mounted only on the upper and lower edge, or may be a four-camera configuration with cameras additionally mounted on (centers of) the left and right edges.

The device may comprise an object recognition unit adapted for recognizing the object on each of the plurality of two-dimensional images. By taking this measure, it may be possible to detect a position, size or other geometrical properties of a body part such as a face or eyes of a user. Therefore, compensation for non-central viewing of the user may be made possible with such a configuration.

The object recognition unit may be adapted for recognizing at least one of the group consisting of a human body, a body part of a human body, eyes of a human body, and a face of a person, as the object. Therefore, the object recognition unit may use geometrical patterns that are typical for the anatomy of human beings in general or for a user having anatomical properties which are pre-stored in the system. In combination with known image processing algorithms, such as pattern recognition routines, edge filters or least square fits, a meaningful evaluation may be made possible.

The second image-processing unit may be adapted for generating the two-dimensional image output data from a geometrical center (for instance a center of gravity) of a display unit as the predefined viewpoint. By taking this measure, a user looking in the display device and being imaged by the cameras can get the impression that she or he is looking directly into the eyes of the communication counterpart.

In a device comprising a display unit for displaying an image of a further object received from the communication partner, the device may also comprise an object-tracking unit adapted for tracking a position of the further object on the display unit. Information indicative of the tracked position of the further object may be supplied to the second image-processing unit as the predefined viewpoint. Therefore, even when a person on the recipient's side is moving or is not located centrally in an image, the position of the object may always be tracked so that a person on the sender side will always look in the eyes of the other person imaged on the screen.

The device may be adapted for implementation within a bidirectional network communication system. For instance, the device may communicate with another similar or different device over a common wired or wireless communication network. In case of a wireless communication network, WLAN, Bluetooth, or other communication protocols may be used. In the context of a wired connection, a bus system implementing cables or the like may be used. The network may be a local network or a wide area network such as the public Internet. In a bidirectional network communication system, the transmitted images may be processed in a manner that both communication participants have the impression that they look in the eyes of the other communication party.

The device for processing image data may be realized as at least one of the group consisting of a videoconference system, a videophoning system, a webcam, an audio surround system, a mobile phone, a television device, a video recorder, a monitor, a gaming device, a laptop, an audio player, a DVD player, a CD player, a harddisk-based media player, an internet radio device, a public entertainment device, an MP3 player, a hi-fi system, a vehicle entertainment device, a car entertainment device, a medical communication system, a body-worn device, a speech communication device, a home cinema system, a home theatre system, a flat television apparatus, an ambiance creation device, a subwoofer, and a music hall system. Other applications are possible as well.

However, although the system according to an embodiment of the invention primarily intends to improve the quality of image data, it is also possible to apply the system for a combination of audio data and visual data. For instance, an embodiment of the invention may be implemented in audiovisual applications like a video player or a home cinema system in which one or more speakers are used.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows a data processing system according to an exemplary embodiment of the invention.

FIG. 2 shows a videoconference network according to an exemplary embodiment of the invention.

### DESCRIPTION OF EMBODIMENTS

The illustration in the drawing is schematical. In different drawings, similar or identical elements are provided with the same reference signs.

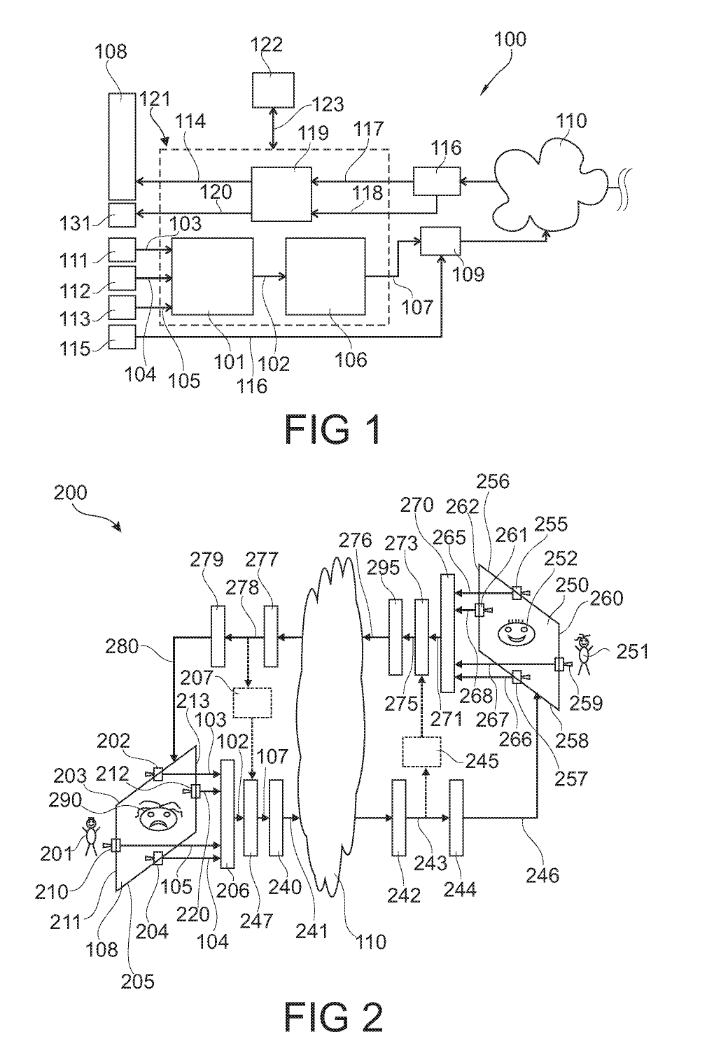

In the following, referring to FIG. 1, an audiovisual data processing apparatus 100 according to an exemplary embodiment of the invention will be explained.

The apparatus 100 is adapted for processing particularly image data representative of a human being participating at a videoconference.

The apparatus 100 comprises a first image-processing-unit 101 adapted for generating three-dimensional image data 102 of the human being based on two-dimensional input data 103 to 105 representative for three different two-dimensional images of the human user taken from three different angular viewpoints.

Furthermore, a second image-processing-unit 106 is provided and adapted for generating two-dimensional output data 107 of the human user representative of a two-dimensional image of the human user from a predefined (virtual) viewpoint, namely of a center of a liquid crystal display 108.

Furthermore, a transmission unit 109 is provided for transmitting the two-dimensional image output data 107 supplied to an input thereof to a receiver (not shown in FIG. 1) communicatively connected to the apparatus 100 via a communication network 110 such as the public Internet. The unit 109 may optionally also encode the two-dimensional image output data 107 in accordance with a specific encoding scheme for the sake of data security and/or data compression.

The apparatus 100 furthermore comprises three cameras 111 to 113 each adapted for generating one of the two-dimensional images 103 to 105 of the human user. The LCD device 108 is adapted for displaying image data 114 supplied from the communication partner (not shown) via the public Internet 110 during the videoconference.

The second image-processing-unit 106 is adapted for generating the two-dimensional output data 107 from a virtual image capturing position in the middle of the LCD device 108 as the predefined viewpoint. In other words, the data 107 represent an image of the human user as obtainable from a camera that would be mounted at a center of the liquid crystal display 108, which would require providing a hole in the liquid crystal display device 108. Thus, this virtual image is calculated on the basis of the real images captured by the cameras 111 to 113.

During a telephone conference, the human user looks into the LCD device 108 to see what his counterpart on the other side of the communication channel does and/or says. On the other hand, the three cameras 111 to 113 continuously or intermittently capture images of the human user, and a microphone 115 captures audio data 116 which are also transmitted via the transmission unit 109 and the public Internet 110 to the recipient. The recipient may send, via the public Internet 110 and a receiver unit 116, image data 117 and audio data 118 which can be processed by a third image-processing-unit 119 and can be displayed as the visual data 114 on the LCD 108 and can be output as audio data 120 by a loudspeaker 131.

The image-processing-units 101, 106 and 119 may be realized as a CPU (central processing unit) 121, or as a microprocessor or any other processing device. The image-processing-units 101, 106 and 119 may be realized as a single processor or as a number of individual processors. Parts of units 109 and 116 may also at least partially be realized as a CPU. Specifically encoding/decoding and multiplexing/demultiplexing (of audio and video) as well as the handling of some network protocols required for transmission/reception may be mapped to a CPU. In other words, the dotted area can be somewhat bigger encapsulating part of units 109, 116 as well.

Furthermore, an input/output device 122 is provided for a bidirectional communication with the CPU 121, thereby exchanging control signals 123. Via the input/output device 122, a user may control operation of the device 100, for instance in order to adjust parameters for a videoconference to user-specific preferences and/or to choose a communication party (for instance by dialing a number). The input/output device 122 may include input elements such as buttons, a joystick, a keypad or even a microphone of a voice recognition system.

With the system 100, it is possible that the second user at the remote side (not shown) gets the impression that the first user of the other side directly looks into the eyes of the second user when the calculated “interpolated” image of the first user is displayed on the display of the second user.

In the following, referring to FIG. 2, a videoconference network system 200 according to an exemplary embodiment of the invention will be explained.

FIG. 2 shows a human user 201 looking on a display 108. A first camera 202 is mounted on a center of an upper edge 203 of the display 108. A second camera 204 is mounted at a center of a lower edge 205 of the display 108. A third camera 210 is mounted along a right-hand side edge 211 of the display 108. A fourth camera 212 is mounted at a central portion of a left-hand side edge 213 of the display device 108. The two-dimensional camera data (captured by the four cameras 202, 204, 210, 212) indicative of different viewpoints regarding the user 201, namely data portions 103 to 105, 220 are supplied to a 3D face modelling unit 206 which is similar to the first processing unit 101 in FIG. 1. Apart from this, unit 206 also serves as an object recognition unit for recognizing the human user 201 on each of the plurality of two-dimensional images encoded in data streams 103 to 105, 220.

The three-dimensional object data 102 indicative of a 3D model of the face of the user 201 is further forwarded to a 2D projection unit 247 which is similar to the second processing unit 106 of FIG. 1. The 2D projection data 107 is then supplied to a source coding unit 240 for source coding, so that correspondingly generated output data 241 is supplied to a network 110 such as the public Internet.

At the recipient side, a source decoding unit 242 generates source decoded data 243 which is supplied to a rendering unit 244 and to a face tracking unit 245. An output of the rendering unit 244 provides displayable data 246 which can be displayed on a display 250 at the side of a user recipient 251. Thus, the image 252 of the user 201 is displayed on the display 250.

In a similar manner as on the user 201 side, the display unit 250 on the user 251 side is provided with a first camera 255 on a center of an upper edge 256, a second camera 257 on a center of a lower edge 258, a third camera 259 on a center of a left-hand side edge 260 and a fourth camera 261 on a center of a right-hand side edge 262. The cameras 255, 257, 259, 261 capture four images of the second user 251 from different viewpoints and provide the corresponding two-dimensional image signals 265 to 268 to a 3D face modelling unit 270.

Three-dimensional model data 271 indicative of the steric properties of the second user 251 is supplied to a 2D projection unit 273 generating a two-dimensional projection 275 of the individual images which are tailored in such a manner that this data gives the impression that the user 251 is captured from a virtual camera located at a center of gravity of the second display unit 250. This data is source-coded in a source coding unit 295, and the source-coded data 276 is transmitted via the network 110 to a source decoding unit 277 for source decoding. Source-decoded data 278 is supplied to a rendering unit 279 which generates displayable data of the image of the second user 251 which is then displayed on the display 108.

Furthermore, the source-decoded data 278 is supplied to the face tracking unit 207. The face tracking units 207, 245 determine the location of the face of the respective user images on the respective screen 108, 250 (for instance center eyes).

Therefore, an image 290 of the second user 251 is displayed on the screen 108. When the users 201, 251 look on the screens 108, 250, they have the impression as if they look in the eyes of their corresponding counterpart 251, 201.

FIG. 2 shows major processing elements involved in a two-way video communication scheme according to an exemplary embodiment of the invention. The elements involved in the alternative embodiment only—face tracking to determine viewpoint for 2D projection—is shown with dotted lines. In an embodiment without face tracking, the 2D projection blocks 247, 273 use the middle of the screen viewpoint as fixed parameter setting.

In addition to the different camera images, the 3D modelling scheme may also employ history of past images from those same cameras to create a more accurate 3D model of the face. Furthermore, the 3D modelling may be optimized to take advantage of the fact that the 3D object to model is a person's face, which may allow the use of pattern recognition techniques.

FIG. 2 shows an example configuration of four cameras 202, 204, 210, 212 and 255, 257, 259, 261 on either communication end point: one camera in the middle of each edge of the screen 108, 250. Alternative configurations are possible. For example, two cameras, one top, one bottom, may be effective in case of a fixed viewpoint in the middle of the screen 108, 250. With a typical screen aspect ratio, the screen height is smaller than the screen width. This means that cameras on top and bottom may deviate less from the ideal camera position than cameras on left and right. Or in other words, with top and bottom cameras, which are closer together than left and right cameras, less interpolation is required and less artefacts result.

Another point is that the output of the face tracking should be in physical screen coordinates. That is, if the output of source decoding has a different resolution than the screen—and scaling/cropping/centring is applied in rendering—then face tracking shall perform the same coordinate transformation, as is effectively applied in rendering.

In yet a further alternative embodiment, the face tracking on the receiving end point may be replaced by receiving face tracking parameters from the sending end point. This may be especially appropriate if the 3D modelling takes advantage of the fact that the 3D object to model is a face. Effectively face tracking is already done at the sending end point and may be reused at the receiving end point. Benefit may be some saving in processing the received image. However, compared to face tracking on the receiving end point, there may be a need for additional signalling over the network interface (that is may involve further standardization) or, in other words, might not be fully backward compatible.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A device for processing image data representative of an object wherein the device comprises
a first image-processing-unit adapted for generating three-dimensional image data of the object based on two-dimensional image input data representative for a plurality of two-dimensional images of the object from different viewpoints;
a second image-processing-unit adapted for generating two-dimensional image output data of the object representative of a two-dimensional view of the object from a predefined viewpoint;
a transmitter unit adapted for providing the two-dimensional image output data for transmission to a communication partner which is communicatively connectable to the device.

2. The device according to claim 1,
comprising a plurality of image capturing units each adapted for generating a portion of the two-dimensional image input data, the respective portion being representative for a respective one of the plurality of two-dimensional images of the object from a respective one of the different viewpoints.

3. The device according to claim 1,
comprising a display unit adapted for displaying an image of a further object received from the communication partner.

4. The device according to claim 2,
wherein the plurality of image capturing units are mounted at respective edge portions of the display unit.

5. The device according to claim 4,
wherein a first one of the plurality of image capturing units is mounted at a central position of an upper edge portion of the display unit, and
wherein a second one of the plurality of image capturing units is mounted at a central position of a lower edge portion of the display unit.

6. The device according to claim 4,
wherein a first one of the plurality of image capturing units is mounted at a central position of a left edge portion of the display unit, and
wherein a second one of the plurality of image capturing units is mounted at a central position of a right edge portion of the display unit.

7. The device according to claim 4,
wherein a first one of the plurality of image capturing units is mounted at a central position of an upper edge portion of the display unit,
wherein a second one of the plurality of image capturing units is mounted at a central position of a lower edge portion of the display unit,
wherein a third one of the plurality of image capturing units is mounted at a central position of a left edge portion of the display unit, and
wherein a forth one of the plurality of image capturing units is mounted at a central position of a right edge portion of the display unit.

8. The device according to claim 1,
comprising an object recognition unit adapted for recognizing the object on each of the plurality of two-dimensional images.

9. The device according to claim 8,
wherein the object recognition unit is adapted for recognizing at least one of the group consisting of a human body, a body part of a human body, eyes of a human body, and a face of a human body, as the object.

10. The device according to claim 1,
wherein the second image-processing-unit is adapted for generating the two-dimensional image output data from a center of a display unit as the predefined viewpoint.

11. The device according to claim 3,
comprising an object tracking unit adapted for tracking a position of the further object on the display unit;
wherein information indicative of the tracked position of the further object is supplied to the second image-processing-unit as the predefined viewpoint.

12. The device according to claim 11,
wherein the object tracking unit adapted for tracking a position of at least one of the group consisting of a human body, a body part of a human body, eyes of a human body, and a face of a human body, as the further object.

13. The device according to claim 1,
adapted for implementation within a bidirectional network communication system.

14. The device according to claim 1,
wherein the transmitter unit is adapted for transmitting the two-dimensional image output data to the communication partner which is located remote with regard to the device.

15. The device according to claim 1,
comprising an encoding unit adapted for encoding the two-dimensional image output data before transmitting the two-dimensional image output data to the communication partner.

16. (canceled)

17. A method of processing image data representative of an object, wherein the method comprises
generating three-dimensional image data of the object based on two-dimensional image input data representative for a plurality of two-dimensional images of the object from different viewpoints;
generating two-dimensional image output data of the object representative of a two-dimensional view of the object from a predefined viewpoint;
providing the two-dimensional image output data for transmission to a communicatively connected communication partner.

18. A computer-readable medium, in which a computer program of processing image data representative of an object is stored, which computer program, when being executed by a processor, is adapted to carry out or control a method according to claim 17.

19. A program element of processing image data representative of an object, which program element, when being executed by a processor, is adapted to carry out or control a method according to claim 17.
